(19) United States
(12) Patent Application Publication
(10) Pub. No.: US 2011/0275255 A1
(43) Pub. Date: Nov. 10, 2011

(54) Personal marine transporter capable of offering the rider the exhilarating feeling of steering a very maneuverable water craft by the direction of his body motion

(76) Inventors: Ching Yin Au, Greenwich, CT (US); Lawrence Au, Vienna, VA (US); Beverly Au, New York, NY (US)

(21) Appl. No.: 12/800,120

(22) Filed: May 10, 2010

(51) Int. Cl. B60F 3/00; G05D 1/00

(52) U.S. Cl. 440/12.5; 701/21

(57) ABSTRACT

A personal marine transporter capable of offering the rider the exhilarating feeling of steering a very maneuverable water craft by the direction of his body motion. Additional features consisting of a handle bar collapsible downward into its housing, a seat with its back rotatable backward and two armrests rotatable forward, reduce the height of the water craft for easy land transportation.

### BACKGROUND OF THE INVENTION

For many, the exhilarating feeling that sports like surfing, water skiing and surf board sailing offer is due to the rider's ability to steer the vehicle by body motion. Similarly the newly invented Segway personal transporter employs body motion steering. The sports mentioned above and the Segway PT all operate on the inverted pendulum principle of supporting a standing person with a narrow platform underneath his feet. The vehicle is inherently unstable, a person, however, can use his body movement to overcome the instability and use the same instability to steer the vehicle. The Segway PT also uses gyroscopes and other sensors plus electronics. The “inverted pendulum” type vehicle has a history dated back to the early 1950's when one of the inventors of this patent was working on a successful design of a personal helicopter with rotors underneath him. A person with experience of riding a bicycle without using his hands for steering can learn to operate the helicopter within minutes. The introduction of the Segway PT had awakened the long time interest in him in designing a body motion steering watercraft.

The sports mentioned above are for a special group of young people. Our development of a body motion steering watercraft was aimed at a broad market for the general public as a desirable but not-too-expensive recreational and utilitarian vehicle. As such, the watercraft would have to be a tamer sit-down version. It would not use the “inverted pendulum” configuration which requires expensive sensors and electronics to keep it absolutely safe; it would use another configuration that is only unstable enough to give the rider a feeling of instability but stable enough to be absolutely safe. The new configuration would require only inexpensive sensors and simpler electronics to accomplish its body motion steering requirement. The watercraft would be more marketable if the following attractive features are added. First, the watercraft's drag in water should be reduced to the minimum so that an electric motor powered by the newly developed lithium ion rechargeable batteries can be used onboard. Second, the watercraft should be capable of self-launching with the rider onboard at a commonly available site such as a launch ramp for boats. Third, the watercraft should be of a size small enough for transportation in a small van or on a small trailer.

### SUMMARY OF THE INVENTION

The search for the alternate configuration for the “inverted pendulum” configuration was an arduous one. No conventional watercraft could be modified to meet the specifications. An unconventional configuration was eventually found that showed great promise. The watercraft is divided into two major parts: a deck with three small pontoons mounted underneath for floatation, one in the front and two in the rear and, attached to the deck further beneath, a submergible hull which contains a water jet turbine driven by an electric motor powered by the best rechargeable batteries available. The submergible hull is designed to have a slightly positive buoyancy just enough to cover its own weight and its contents and almost all the weight of the floating structure. Thus, the three small pontoons only have to support the weight of the rider. The usual bow wave drag and frictional drag, in this case, is reduced to the minimum, due to the small size of the pontoons. The submergible hull, with its streamlined shape, encounters no bow wave drag; with a frictional drag reduction coating, the frictional drag imposed on the submergible hull is small relative to the weight it supports. The demand on the propulsive system is therefore smaller. The batteries will last longer. The placement of the pontoons relative to the location of the rider and the shape of the submergible is determined by the requirement that the watercraft be as manueverable as possible and be absolutely safe with respect of the possibility of tipping over. In this case, the weight of the submergible hull functions as a ballast of some sailing boats and the vertical height of the submergible hull functions as a center board of some sailing boats. They both make their contribution in preventing the watercraft from tipping over, rendering the watercraft absolutely safe.

However, the chosen configuration, with the submergible hull mounted rigidly to the deck presents a serious problem. If the submergible hull accidentally hit something, the watercraft will tip violently or sustain heavy damage to the submergible hull.

A novel mounting method was found that not only solves the problem above but also fullfills the specifications of self launching and reducing the size of the watercraft to a small enough package for convenient transportation and storage. The submergible hull will be attached to the deck with two sets of parallel bars of equal length in such an arrangement that the submergible hull will move rearward and upward when hitting an object and, thus, going over the object safely. Furthermore, two wheels will be attached to the rear of the submergible hull to help riding over an object. If the submergible hull is moved by the rider upward and rearward to the preset landing position and if a pair of retractable front wheels at the front of the deck is lowered, the watercraft is set for landing on the launching ramp. A final maneuver of folding down the arm rests and the back of the seat and lowering the handle bars would reduce the watercraft to a small enough wheeled package for transportation in a small van and for storage. Self-launching with the rider onboard is simply the reversed procedure except that, with the help of gravity and the downgrade of the ramp, enough momentum is gained to deliver the watercraft to deep enough water to retract the front wheels, lower the submergible hull and speed away.

### BRIEF DESCRIPTION OF THE DRAWINGS

FIG. 1 is a side view of the watercraft on land.

FIG. 2 is the same side view as FIG. 1 except that part of the submerged hull is removed to expose the water jet turbine located in the middle of the submergible hull.

FIG. 3 is the same side view as FIG. 1 except that the back of the chair and the arm rest are folded and the handle bars are pushed down.

FIG. 4 is the rear view of the watercraft on land.

FIG. 5 is the top view of watercraft.

FIG. 6 is the front view of the watercraft on land.

FIG. 7 is the same front view as FIG. 4 except that the foot rest segment is flipped 180 degrees toward the side of the watercraft, resting on top of the deck.

FIG. 8 is the same side view as FIG. 1 with the rider sitting in the neutral position.

FIG. 9 is a side view of the watercraft floating on water.

FIG. 10 is the same side view as FIG. 9 with the upper body of rider leaning forward commanding the watercraft to move forward.

FIG. 11 is a side view of the watercraft with everything below the deck removed so that the pressure sensor can be identified.

FIG. 12 is the same side view as FIG. 11 except that the front of the deck is pitched up ward due to the waves. The accelerometers are identified.

FIG. 13 is the same top view as FIG. 5 except that the rear pontoons are rotated toward to turn the watercraft to the right.

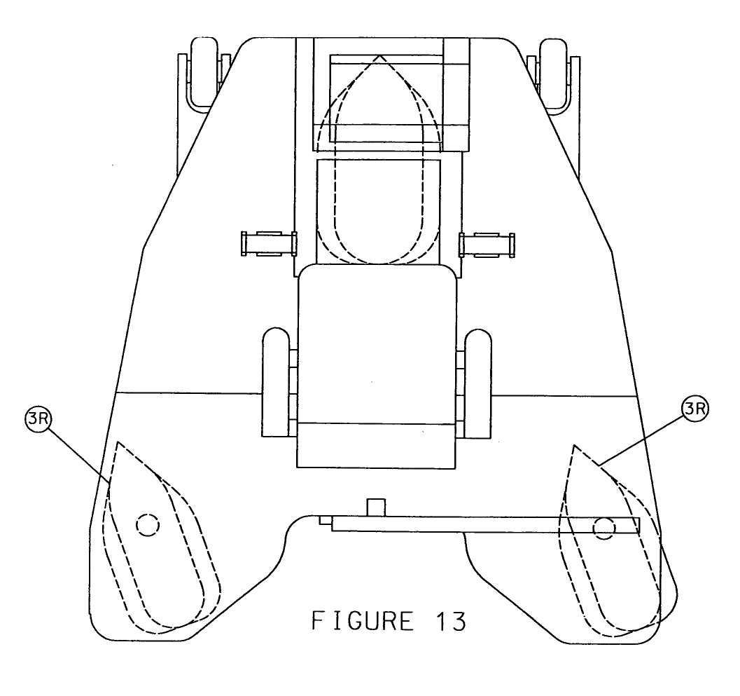

FIG. 14 is the same top view as FIG. 13 except that the left pontoon is rotated toward the left and the right pontoon is rotated toward the right to slow down the watercraft.

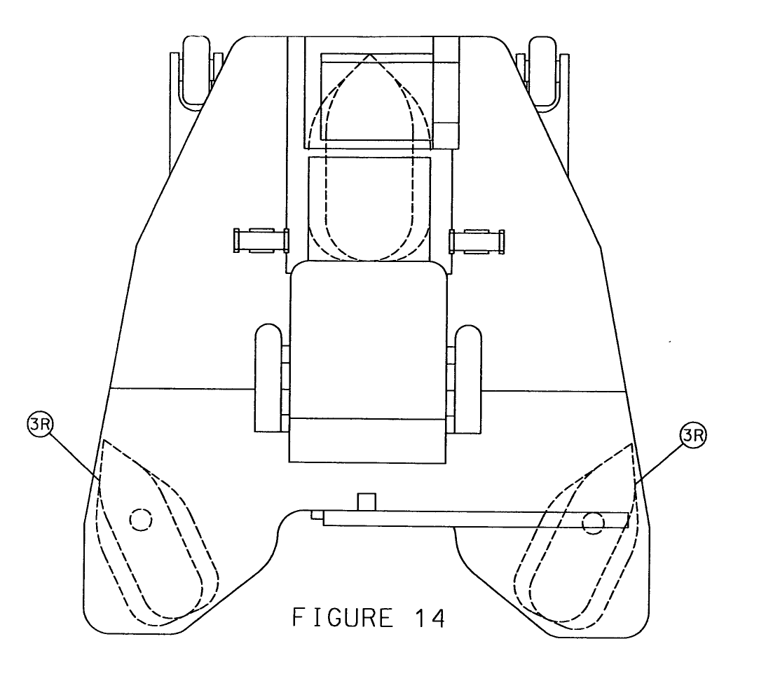

### DETAILED DESCRIPTIONS

The first group of eight figures illustrate graphically the appearance of the watercraft as it is on land. It follows the logic that the watercraft is first transported to the launching ramp. After all components are checked out, the launching process will start. The second group of six figures present the watercraft as it is on water. After the launch, the front landing gears will be retracted and the submerged hull will be deployed. Then the watercraft is ready to go.

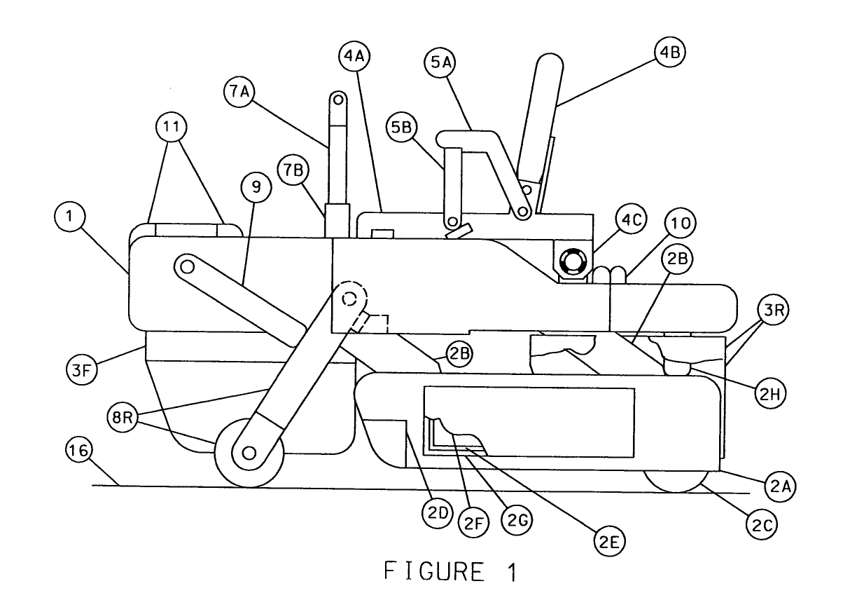

FIG. 1 is a side view of the watercraft on land, in which the component 1 is the deck. Below the deck are the submerged hull 2A which is attached to the deck by two pairs of parallel bars 2B, a front pontoon 3F which is fastened to the deck and two rear pontoons 3R which are connected to the deck via a rotating joint 12 (not visible here). The submerged hull itself contains two landing wheels 2C, two protective caps 2D, two battery packs 2E, mounting frame 2G and battery compartment cover 2F. On the right side of the deck is the right retractable landing gear assembly 8R with its locking bar 9. Above the deck are the seat 4A with its foldable back 4B, the arm rest 5A with its support 5B, and the rear seat support 4C. In front of the seat are two vertically retractable handle bars 7A and their housing 7B (the handlebars are at its highest position). Behind the seat is the retractable boarding pole 10 for assisting boarding from the rear of the watercraft when raised (it is at its down position). At the front of the deck is a portion of the rotatable foot rest segment 11 with most of it hidden below the top of the deck; while landing the foot rest segment is rotated upward and to the side to allow the rider to get off. Finally, the ground is 16.

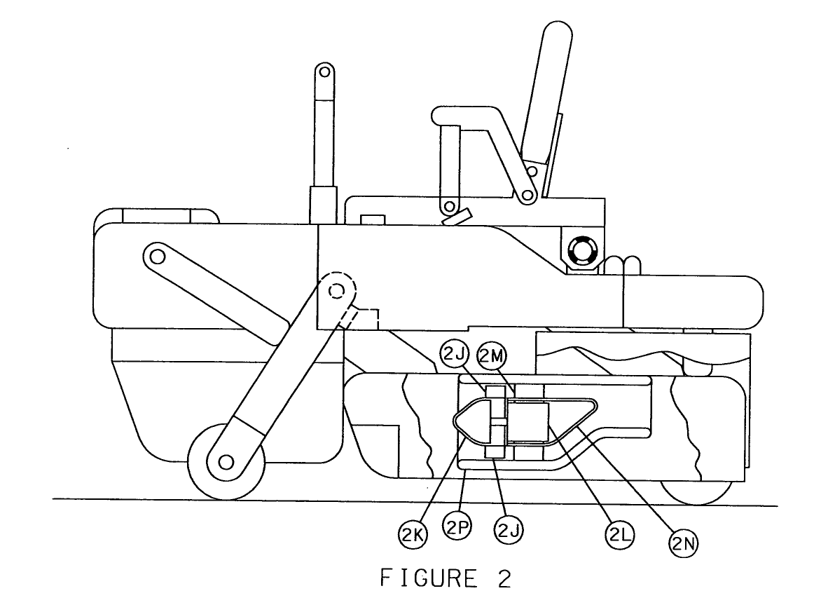

FIG. 2 is the same side view as FIG. 1 except that part of the side of the submerged hull is removed to reveal the middle section which contains the water jet turbine 2J is one of turbine blades attached to the entrance cone 2K which is driven by a electric motor 2L. 2M is one of the motor support fins that supports the motor and the exit cone 2N.

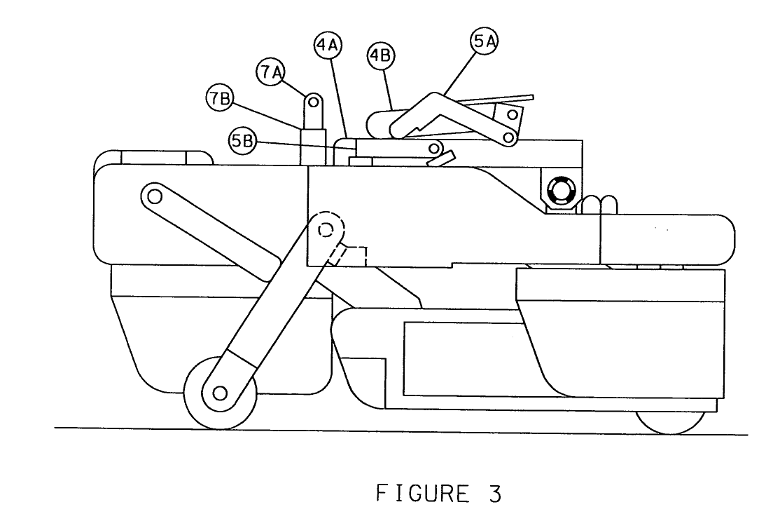

FIG. 3 is the same side view as FIG. 1 except that the back 4B of the seat 4A is folded down and the same has been done to the arm rest 5A and its support 5B. Handle bar 7A is moved down into its support tube 7B to the lowest position. The watercraft is now more compact for the transportation in a van.

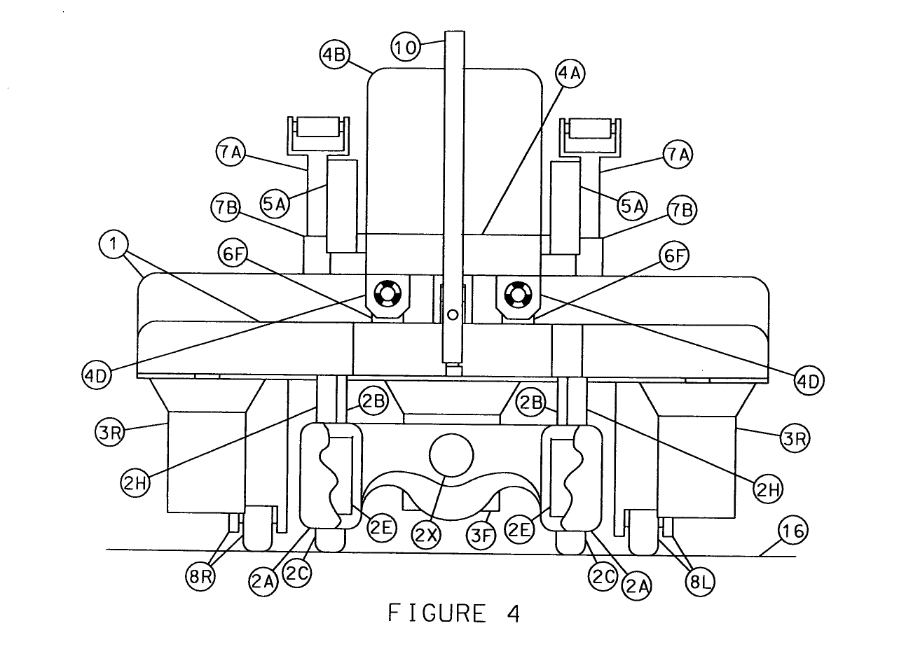

FIG. 4 is the rear view of the watercraft on land. All the component numbers has been identified previously except 8L, the left landing gear assembly which is not visible in the side view FIG. 1. The foldable boarding pole 10 has been raised to the vertical position to facilitate boarding. The rider just steps on the top surface of the submergeable hull 2A with one foot and then steps on the lower part of the deck 1 while holding on the boarding pole.

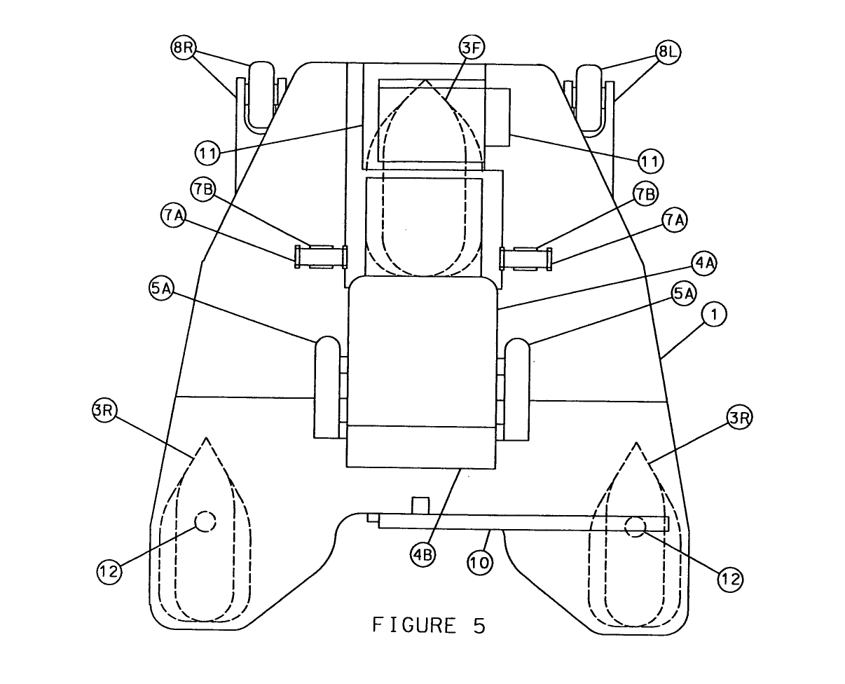

FIG. 5 is a top view of the watercraft. All the component numbers has been identified previously except 12 the rotatable joint through which the rear pontoon 3R is attached to the bottom of the deck 1.

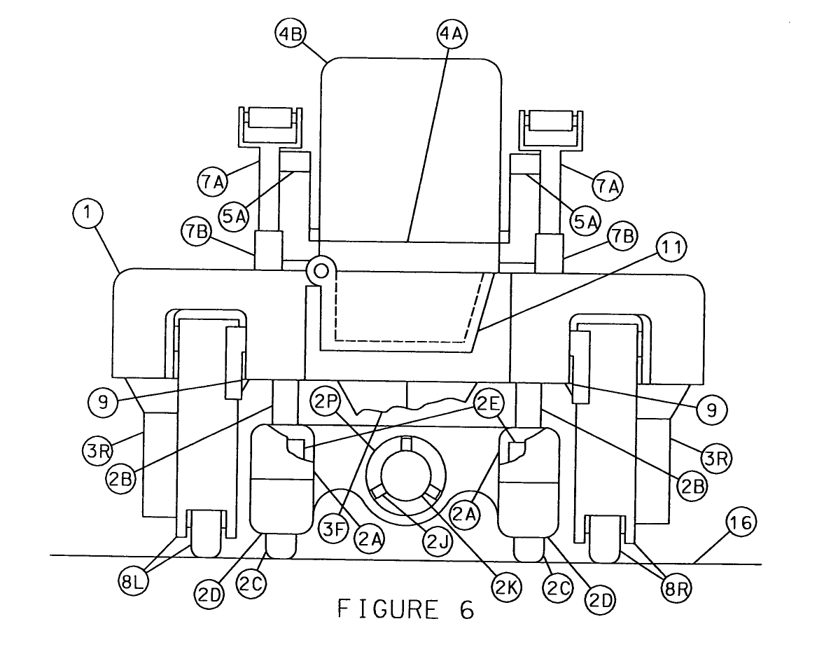

FIG. 6 is a front view of the watercraft on land. All component numbers has been identified previously except 2K the entrance cone of the water jet, 2P the turbine housing and 2J the turbine blade. The foot rest segment 11 is entirely visible here.

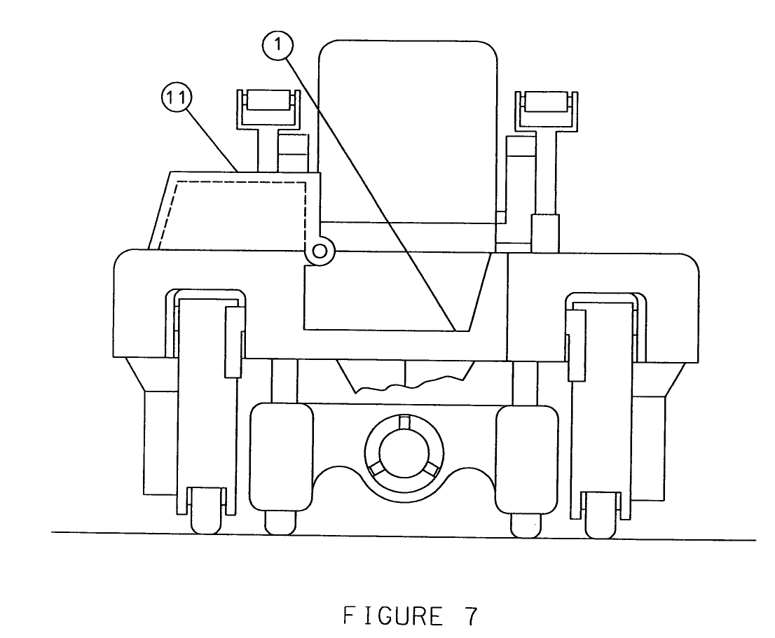

FIG. 7 is the same front view as in FIG. 6 except that the foot rest segment 11 is rotated 180 degrees upward and to the side, resting on top of the deck. Thus, a lower portion of the deck 1 is exposed, allowing the rider to step off the watercraft on landing.

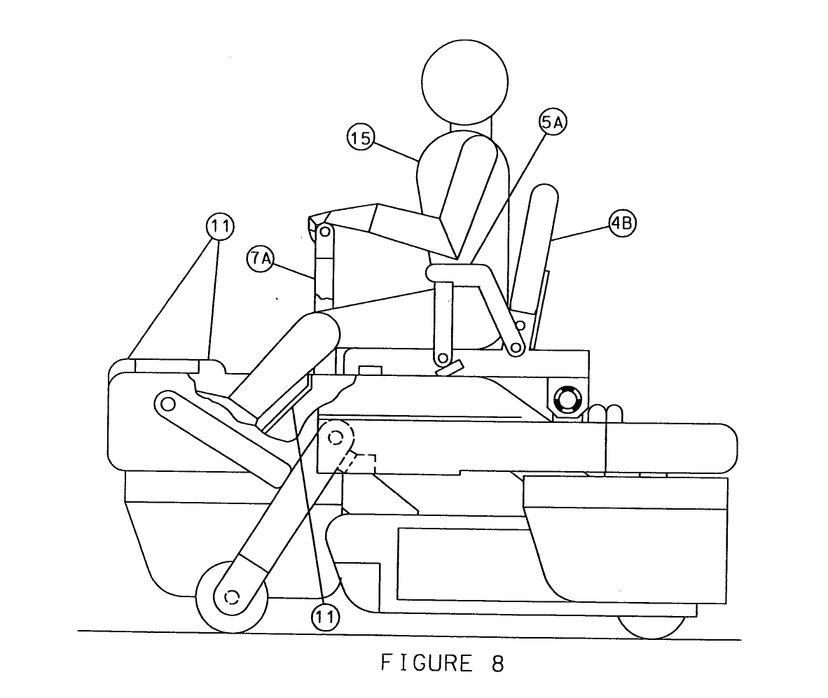

FIG. 8 is the same side view as in FIG. 1 except that the rider 15 is now onboard. He is sitting upright with his hands on the handle bars 7A's and his feet resting on the foot rest segment 11. The back of the seat 4B and the arm rests 5A's essentially define the center of gravity of the rider so that the sensors works properly. The watercraft is now ready to roll down the launching ramp and gains enough speed as it hits water to let its momentum to deliver it to deep enough water to deploy the submergible hull and to retract the front landing gear assemblies.

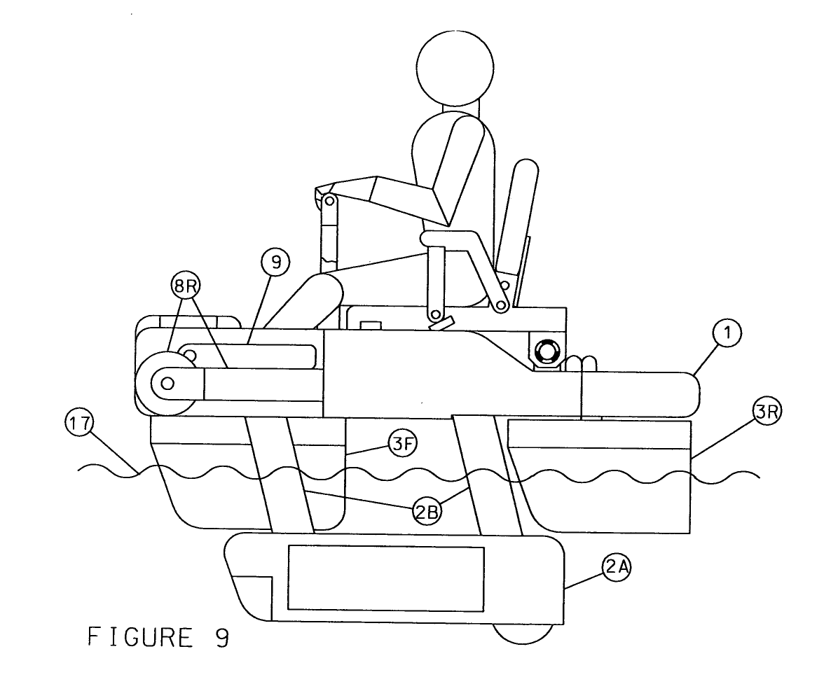

FIG. 9 is a side view of the watercraft on water. The submergible hull 2A has been moved forward and downward by the two sets of parallel links 2B to a preset depth below the water surface 17 and the right front landing gear assemble 8R and its locking bar 9 has been retracted to the side of the deck 1. The front pontoon 3F and the two rear pontoon 3R's are shown to have just enough draft to support rider's weight.

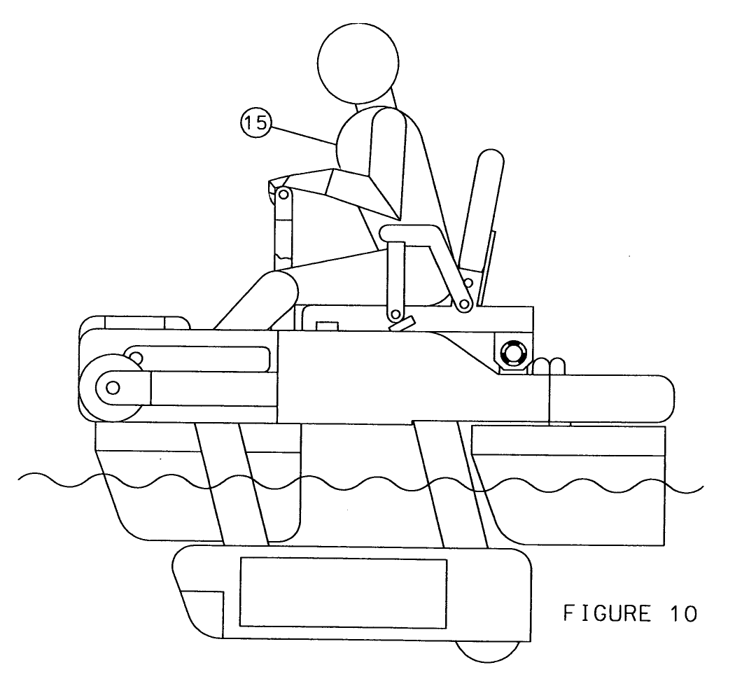

FIG. 10 is the same side view of the watercraft on water as in FIG. 9 except the rider 15 is leaning forward with his upper body to instruct the watercraft to go forward at a preset initial speed as the sensors together with computer send signal to start the water jet.

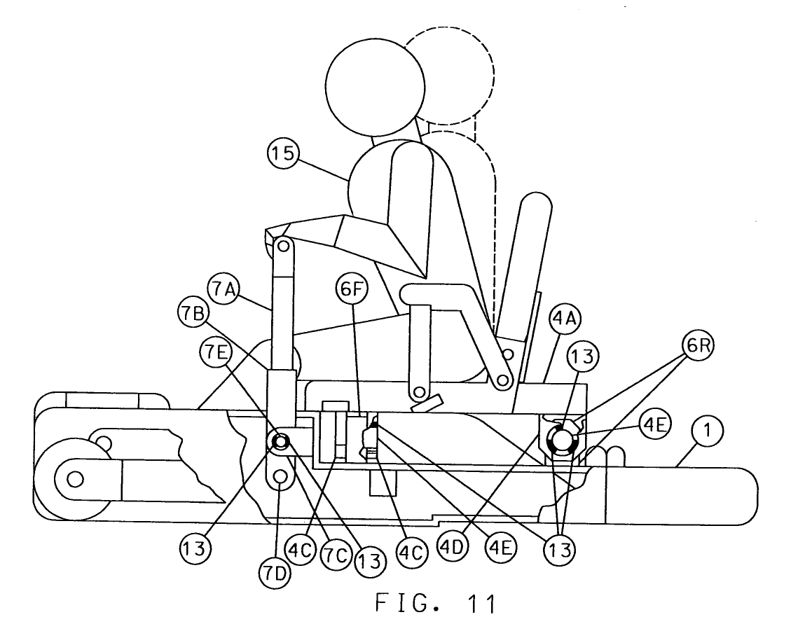

FIG. 11 is a side view of the watercraft on water with only the components from the deck and above showing. The upper body of the rider is shown in two positions: the dotted lines represent the upright and neutral position which has a weight distribution pattern the sensors under the seat and the computer recognize as the quiescent state for the watercraft (the water jet is idle) and the solid lines of the rider's upper body represent the forward leaning position which has a weight distribution pattern the sensors and the computer recognize as the forward moving state (the water jet is running at a preset initial speed; any speed increase is achieved with the rider's operating the throttle on one of the handle bars). There are two other states that the rider's upper body can control; they are the right turn state and the left turn state. All the sensors for the different states are located underneath the seat 4A. The sensors for the forward moving state are located at a spot on the longitudinal center line at the rear of the seat. Mounted on the bottom surface of the seat is an inverted U-shape bracket 4D, with the two vertical side of the U oriented parallel to the longitudinal center line. A circular hole is bored through both vertical sides of the U to accommodate the outer curved edge of three identical pressure sensitive plastic sensors 13 located at twelve o'clock, four o'clock and eight o'clock. A vertical lug 6R mounted on the deck 1 fills the space between the two vertical sides of the U with a sliding fit. A circular cross pin 4E goes through lug 6R with a press fit and makes snug contact with the inner curved edge of the sensors. The sensors in this arrangement is thus able to recognize the forward moving state and the computer will execute accordingly. Toward the front and to the left of the seat are the sensors for the left turn state; they are in a similar structure except that the structure is rotated 90 degrees with respect the center line of the structure. Here 4C is the inverted U-shape bracket and 6F is the central lug. Only one sensor 13 (the 12 o'clock one) can be seen here. Hidden behind the left turn sensors and at the right side of the seat are the right turn sensors in an identical structure. The bottom end of the handle bar support tube 7B is mounted on the deck with a pin 7D. If the rider pull the handle bar backward, the handle bar would have move backward except that it is constrained by a U-shape bracket 7C mounted on the deck 1 and to the handle bar support tube 7B just above the pin 7D. The U-shape bracket is similar to the one under the rear of the seat except the sides of the U is pointing to the front of the watercraft. A cross pin 7E and two sensors 13 (one at 3 o'clock and one at 9 o'clock) complete the assembly. Now, if the rider pulls the handle bars backward, the sensor at 3 o'clock of both handle bars will be under compression, the increase in voltage will caused the computer to go into the stop mode which consists of putting the brakes on and reversing the water jet. With the addition of the sensor at 9 o'clock, the rider can choose to steer the watercraft manually instead of by body leaning. In manual steering, the rider steer the watercraft right by pushing the left handle bar forward and pulling the right handle bar backward. Pushing the right handle bar forward and pulling the left handle bar backward will cause the watercraft to veer to the left.

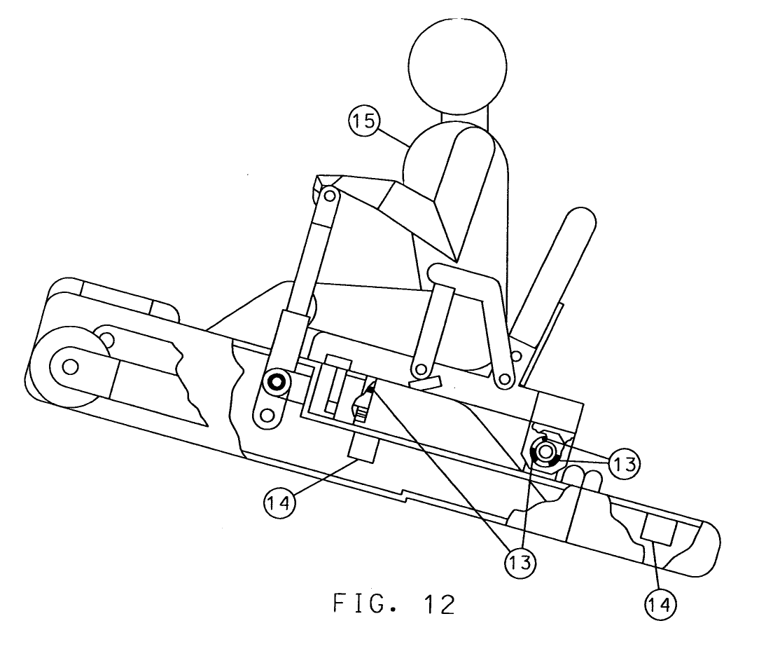

FIG. 12 is the same side view of the watercraft on water as in FIG. 11 except the front of the watercraft is shown pitched upward and the rear downward. The action of the waves typically cause any part of the watercraft to go constantly either up or down in a periodic manner. Because the body steering commands are a steady state affair, the computer should be able to ignore the added signals due to the action of moderate waves. However, when four accelerometers are mounted on the deck at the following four locations: front, rear, right and left, the signals picked up by the four accelerometers will further assist the computer to ignore the action of the waves. In this view, the accelerometer 14 at the rear and the left are visible; the accelerometers at the left front and the right front are hidden. If the computer fails to behave properly, the rider can always switch to the manual steering mode.

We claim:

1. A water craft comprising: one deck with the following items attached to it: one centrally located front pantoon rigidly bolted to the bottom of said deck, two rear pontoons, one at each side, vertically mounted to the bottom of said deck in the fashion of a rudder so that said rear pontoons also serve as rudders, a submerged hull that is vertically adjustable by virtue of attaching it to said deck through four parallel and equal rotatable linkage bars, one or more water jet(s) installed in said submerged hull with water inlet and outlet, three pressure sensitive plastic sensors that detect the weight distribution of the rider are mounted underneath said rider's seat, one at the front and two at the rear, three accelerometers mounted on the deck, similarly, two pressure sensitive plastic sensors are mounted at the rider's handle bars housing to detect said bar's forward (counterclockwise) rotation and rearward (clockwise) rotation and finally a computer to receive signals from all the sensors to control the direction and speed of the water craft, from zero to a preset maximum.

2. A water craft in accordance with claim 1, further comprising: two retractable landing gears rotatably attached to both sides of the front, two power-driven landing wheels attached to the bottom of the submerged hull, and finally, to reduce the height of the water craft for easy land transportation, an additional three features consisting of: a handle bar collapsible downward into its housing, a seat with its back rotatable backward and two armrests rotatable forward.
